(19) United States
(12) Patent Application Publication
(10) Pub. No.: US 2024/0231100 A9
(43) Pub. Date: Jul. 11, 2024

(54) METHODS AND APPARATUSES FOR IMPLEMENTING VARIED OPTICAL GRATING GEOMETRIES IN AN AUGMENTED REALITY DISPLAY

(71) Applicant: GOOGLE LLC, Mountain View, CA (US)

(72) Inventors: Wei Jin, Saratoga, CA (US); Joseph Daniel Lowney, Tucson, AZ (US); Lu Tian, Palo Alto, CA (US); Qinglan Huang, Mountain View, CA (US); Thomas Mercier, Weston, FL (US)

(21) Appl. No.: 18/372,222

(22) Filed: Sep. 25, 2023

Related U.S. Application Data
(60) Provisional application No. 63/417,722, filed on Oct. 20, 2022.

(51) Int. Cl. G02B 27/01; G02B 6/34

(52) U.S. Cl. CPC G02B 27/0172; G02B 6/34; G02B 2027/0178

(57) ABSTRACT

An augmented-reality (AR) eyewear display utilizes an optical waveguide having multi-layered optical gratings in a repeating arrangement. The optical gratings include varying depths, slope angles, lengths, and/or widths in order to tune the gratings to provide an improved AR eyewear display. By using the different configurations of two-dimensional or three-dimensional gratings disclosed herein in a waveguide of an AR eyewear display, optical characteristics of the waveguide are optimized to provide, e.g., high resolution and/or contrast, high display uniformity, high input coupling efficiency, and/or high output coupling efficiency. Accordingly, in some embodiments, aspects of the present disclosure enable lower-power AR eyewear displays to produce the same quality of display of a higher-power conventional AR eyewear display waveguide.

### CROSS-REFERENCE TO RELATED APPLICATIONS

The present application claims priority to U.S. Provisional Application No. 63/417,722, entitled “FABRICATION OF STAIRCASE GRATING MODULATION MASTER AND WORKING STAMP” and filed on Oct. 20, 2022, the entirety of which is incorporated by reference herein.

### BACKGROUND

In an augmented reality (AR) or mixed reality (XR) eyewear display, light from an image source is coupled into a light guide substrate, generally referred to as a waveguide, by an input optical coupling such as an in-coupling grating (i.e., an “incoupler”). The input optical coupling can be formed on one or more surfaces of the substrate or disposed within the substrate. Once the light has been coupled into the waveguide, the incoupled light is “guided” through the substrate, typically by multiple instances of total internal reflection, to then be directed out of the waveguide by an output optical coupling (i.e., an “outcoupler”), which can also take the form of an optical grating. The outcoupled light projected from the waveguide overlaps at an eye relief distance from the waveguide forming an exit pupil, within which a virtual image generated by the image source can be viewed by the user of the eyewear display. However, waveguides used in AR displays often suffer from one or more of limited resolution, limited contrast, low display uniformity, low input coupling efficiency, or low output coupling efficiency.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a diagram illustrating a rear perspective view of an augmented reality display device implementing an optical waveguide with multi-layered optical gratings in a repeating arrangement in accordance with some embodiments.

FIG. 2 is a diagram illustrating a cross-section view of an example implementation of the waveguide of FIG. 1 in accordance with some embodiments.

FIG. 3 is a diagram illustrating a partial cross-section view of a portion of an implementation of the waveguide of FIG. 2 with varying, repeating grating depths in accordance with some embodiments.

FIG. 4 is a set of diagrams illustrating plan views of example varied optical grating geometries with varying, repeating grating depths in accordance with some embodiments.

FIG. 5 is a diagram illustrating a cross-section view of a portion of another implementation of the waveguide of FIG. 2 with repeating optical grating depths and slope angles facing opposite directions to create a symmetric geometry in accordance with some embodiments.

FIG. 6 is a set of diagrams illustrating corresponding cross-section views of a portion of corresponding implementations of the waveguide of FIG. 2 and having varied optical grating geometries with varying slope angles facing various directions in accordance with some embodiments.

FIG. 7 is a diagram illustrating a plan view of an implementation of the waveguide of FIG. 2 with three-dimensional varying, repeating gratings in accordance with some embodiments.

FIG. 8 is a diagram illustrating a cross-sectional view of the waveguide of FIG. 7 along the line 8-8 in accordance with some embodiments.

FIG. 9 is a diagram illustrating a cross-sectional view of the waveguide of FIG. 7 along the line 9-9 in accordance with some embodiments.

FIG. 10 is a diagram illustrating a cross-section view of a portion of the waveguide implementing the gratings of FIG. 7 with varying, repeating grating depths and further illustrating an example of light transmission through the waveguide in accordance with some embodiments.

FIG. 11 is a flow diagram of a method of forming multi-layered optical gratings in a repeated arrangement in accordance with some embodiments.

### DETAILED DESCRIPTION

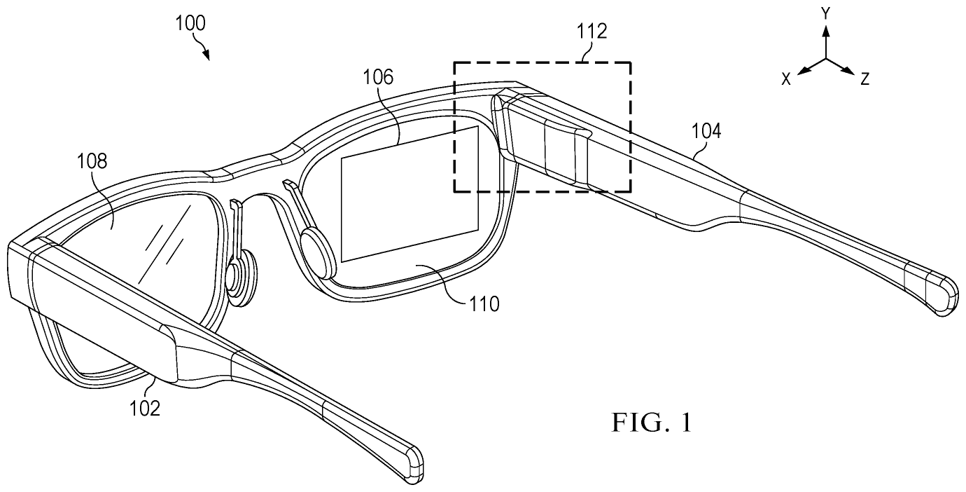

FIGS. 1-11 illustrate devices and techniques for implementing multi-layered optical gratings in a repeating arrangement on an optical waveguide. In some embodiments, the gratings include one or more of varying depths, varying slope angles, varying lengths, or varying widths in order to tune the gratings to the particular use context for the optical waveguide in order to provide an improved AR eyewear display. In some embodiments, the gratings are repeated along two or more axes. Generally, by using the different configurations of two-dimensional or three-dimensional gratings disclosed herein in a waveguide of an AR eyewear display, optical characteristics of the waveguide can be optimized to provide, e.g., one or more of high resolution and/or contrast, high display uniformity, high input coupling efficiency, or high output coupling efficiency. Accordingly, in some embodiments, aspects of the present disclosure enable lower-power AR eyewear displays to produce the same quality of display of a higher-power conventional AR eyewear display waveguide.

FIG. 1 illustrates an AR eyewear display system 100 implementing multi-layered optical gratings in a repeating arrangement on an optical waveguide in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes a spectacles or eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an augmented reality display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) in the light path between the IC and OC, or in combination with the OC, in order to increase the dimensions of the display exit pupil. In some embodiments, the regions of the waveguide including an IC, OC, and/or EPE include multi-layered optical gratings in a repeating arrangement to improve their optical characteristics. Moreover, each of the lens elements 108, 110 is sufficiently transparent to allow a user to see through the lens elements to provide a field of view of the user's real-world environment such that the image appears superimposed over at least a portion of the real-world environment.

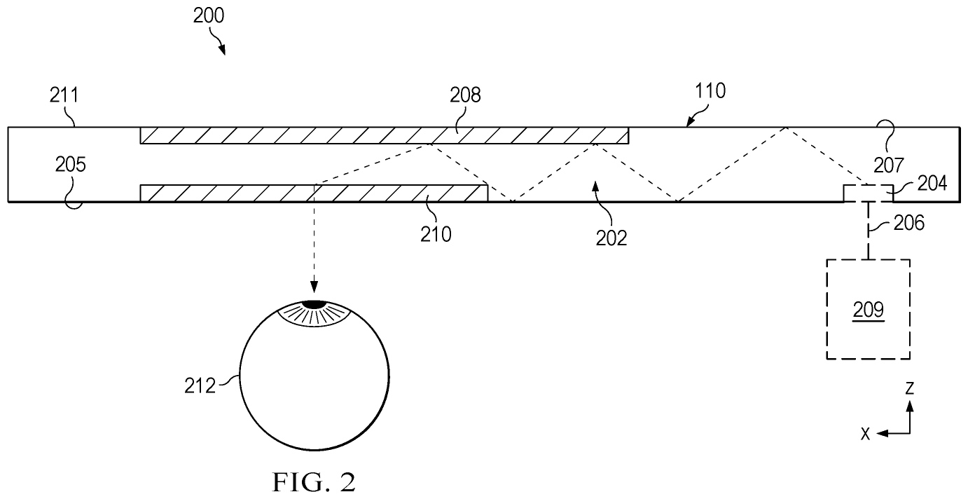

FIG. 2 depicts a cross-section view 200 of an implementation of a lens element 110 of an AR eyewear display system such as AR eyewear display system 100. Note that for purposes of illustration, at least some dimensions in the Z direction are exaggerated for improved visibility of the represented aspects. In this example implementation, a waveguide 202, which may form a portion of the lens element 110 of FIG. 1, implements diffractive optical structures in a region 208 on the opposite side of the waveguide 202 as diffractive optical structures of a region 210. In particular, the diffractive optical structures of an IC 204 are implemented on an eye-facing side 205 of the lens element 110. Likewise, the diffractive optical structures of region 210 (which provide OC functionality) are implemented at the eye-facing side 205. Further in the illustrated implementation, the diffractive optical structures of region 208 (which provide EPE functionality) are implemented at a world-facing side 207 of the lens element 110 that is opposite the eye-facing side 205. Thus, under this approach, display light 206 from a light source 209 is incoupled to the waveguide 202 via the IC 204, and propagated (through total internal reflection in this example) toward the region 208, whereupon the diffractive optical structures of the region 208 diffract the incident display light for exit pupil expansion purposes, and the resulting light is propagated to the diffractive optical structures of the region 210, which output the display light toward a user's eye 212. In other implementations, the positions of regions 208 and 210 may be reversed, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics. In some embodiments, one or more external regions of the lens element 110 on one or both of the world-facing side 207 and eye-facing side 205, such as region 211, include multi-layered optical gratings in a repeating arrangement.

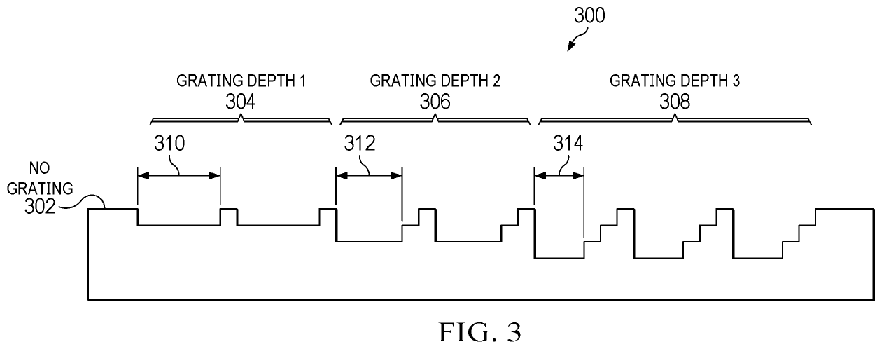

FIG. 3 is a diagram illustrating a cross-section view of a portion of a waveguide 300 with varying, repeating grating depths in accordance with some embodiments. In embodiments, waveguide 300 is an example implementation of the waveguide 202 of FIG. 2. As will be better understood from the following description and corresponding illustrations of FIGS. 3-6, “repeating” gratings refers to the presence of multiple, adjacent instances of the same grating (that is, the same grating geometries) within a corresponding region, and “varying grating depths” refers to different gratings in different regions having different depth geometries. By using appropriately configured varying, repeating grating depths in an optical waveguide, such as in ICs, OCs, and/or EPEs, among other components, optical characteristics of the waveguide are optimized to provide, e.g., high resolution and/or contrast displays, high display uniformity, high input coupling efficiency, and/or high output coupling efficiency. As shown, the waveguide 300 includes a region 302 with no grating, a region 304 with a first grating depth, a region 306 with a second grating depth greater than the first grating depth, and a region 308 with third grating depth greater than the second grating depth. In this particular example, the regions 304 and 306 of the waveguide 300 with the first and second grating depths each includes two repeated gratings, while the region 308 with the third grating depth includes three repeated gratings, that is, multiple instances of the same gratings disposed adjacent to one another. In some embodiments, the gratings are formed using any appropriate additive or subtractive manufacturing processes, such as deposition, lithography, and/or stamping.

In some embodiments, the region 304 includes a first grating width 310, which is duplicated in gratings in the region 306 and region 308. The region 306 also includes a second grating width 312, which is duplicated in gratings in the region 308 to the second grating depth. The gratings of region 308 includes a third grating width 314. However, it should be understood that FIG. 3 is only an example implementation; in some embodiments, the waveguide 300 includes more or fewer than three grating depths and more or fewer than three grating widths.

In some instances, the first grating width 310, the second grating width 312, and the third grating width 314 are selected to better optimize optical characteristics of the waveguide 300. For example, in some embodiments, the third grating width 314 is shorter than the second grating width 312, which is shorter than the first grating width 310. In some embodiments, the third grating width 314 is half the width of the second grating width 312, which is half the width of the first grating width 310. In other embodiments, the third grating width 314 is one-third the width of the first grating width 310 and the second grating width 312 is half the width of the first grating width 310. Generally, the first grating width 310, the second grating width 312, and the third grating width 314, as well as their associated depths, are selected to optimize optical characteristics of the waveguide 300 such as an optical transfer function, a modulation transfer function, a resolution, and/or a contrast, among others.

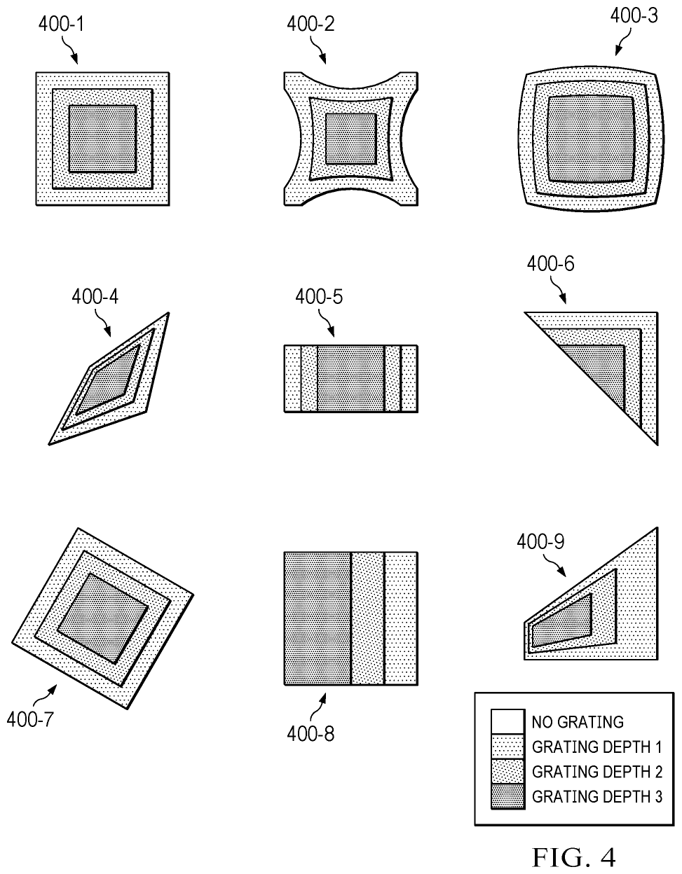

FIG. 4 is a set of diagrams illustrating plan views of different optical gratings 400 with varied geometries for use as optical gratings of varying, repeating grating depths like those of FIG. 3 in accordance with some embodiments. As shown, in some embodiments, a central portion of the varied optical grating geometries 400, such as in geometries 400-1, 400-2, 400-3, 400-4, 400-5, 400-7, and 400-9, includes the third grating depth, while regions including sequentially lower depths (e.g., grating depth 2 306 and grating depth 1 304) surround the central portion. However, in some embodiments, a central portion includes a smaller grating depth (e.g., grating depth 1 304) or no grating 302 compared to its concentric layers (e.g., grating depth 2 306 and grating depth 3 308, disposed in either order concentrically or radiating outward from the central portion). In other embodiments, such as in geometries 400-6 and 400-8, a first edge or portion of the grating includes grating depth 3 308, while regions including sequentially smaller depths (e.g., grating depth 2 306 and grating depth 1 304) radiate substantially radially (e.g., geometry 400-6) or linearly (e.g., geometry 400-8) from the first edge or portion of the grating with grating depth 3 308.

Notably, although square corners and straight, continuous lines are utilized for many of the example varied optical grating geometries 400 of FIG. 4, in some embodiments, corners are rounded, edges include zig-zag patterns (e.g., similar to a sine waveform, a square waveform, a sawtooth waveform, and/or a triangle waveform). Further, although the grating regions of different depths include similar shapes, e.g., in geometry 400-1, each grating depth region is deposited in a square shape, in some embodiments, the grating regions of different depths are deposited in significantly different shapes, as shown in geometry 400-2. Generally, geometry 400-1 illustrates grating regions disposed in concentric square shapes; geometry 400-2 illustrates grating regions disposed in concentric shapes of different geometries; geometry 400-3 illustrates grating regions disposed in concentric rounded square shapes; geometry 400-4 illustrates grating regions disposed in concentric diamond shapes; geometry 400-5 illustrates grating regions disposed in a two-sided linear gradient; geometry 400-6 illustrates grating regions disposed in a triangular gradient; geometry 400-7 illustrates grating regions disposed in tilted square shapes; geometry 400-8 illustrates grating regions disposed in a single-sided linear gradient; and geometry 400-9 illustrates grating regions disposed in concentric, skewed rectangular shapes. However, it is noted that these grating regions are only examples. In some embodiments, geometries of grating depth 3 308, grating depth 2 306, and grating depth 1 304 are each distinct from one another; for example, in some embodiments, a square, a circle, and an oval define concentric geometries of grating depth 3 308, grating depth 2 306, and grating depth 1 304, respectively.

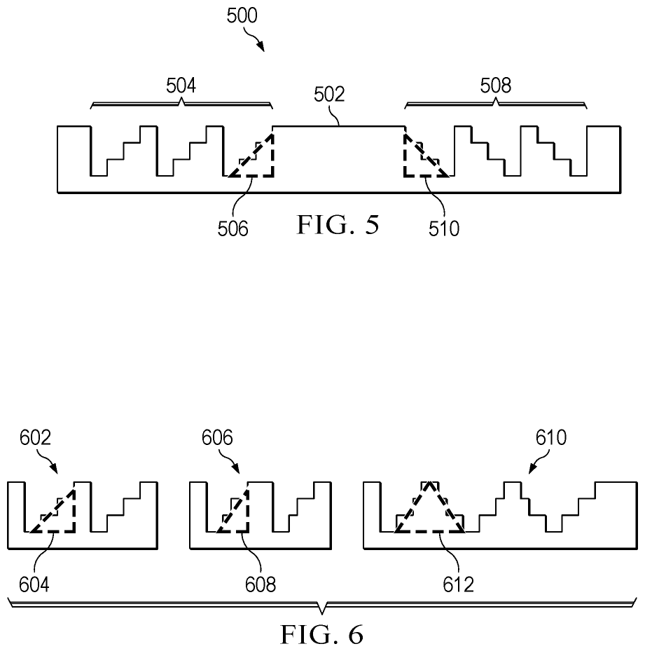

FIG. 5 is a diagram illustrating a cross-section view of a portion of a waveguide 500 with repeating optical grating depths and slope angles facing opposite directions to create a symmetric geometry in accordance with some embodiments. In embodiments, waveguide 300 is an example implementation of the waveguide 202 of FIG. 2. As shown, region 504 of the waveguide 500 includes repeating optical grating depths and slope angles 506 facing (e.g., with descending depths propagating in) a left-hand direction, while region 508 of the waveguide 500 includes repeating optical grating depths and slope angles 510 facing a right-hand direction. In some embodiments, the waveguide 500 additionally or alternatively includes slope angles all facing a single direction and/or slope angles facing toward each other, e.g., toward a particular location of the waveguide 500, such as location 502. In some embodiments, an arrangement like that shown in FIG. 5 forms at least a portion of an IC, an OC, or an EPE. In some embodiments, the region 504 corresponds to an IC and the region 508 corresponds to an OC.

FIG. 6 is a set of diagrams illustrating cross-section views of varied optical grating geometries with varying slope angles facing various directions for use as varied, repeating optical gratings in accordance with some embodiments. As shown in FIG. 6, the first optical gratings 602 include a first slope angle 604, the second optical gratings 606 include a second slope angle 608 different from the first slope angle 604, and the third optical gratings 610 include a third slope angle 612 different from the first slope angle 604 and the second slope angle 608 as well as slope angles facing different directions (i.e., left-facing and right-facing slope angles). In some embodiments, a waveguide includes a single slope angle for every grating; in other embodiments, a waveguide includes a number of different slope angles corresponding to different grating depths or increasing or decreasing slope angles for gratings over a length of the waveguide.

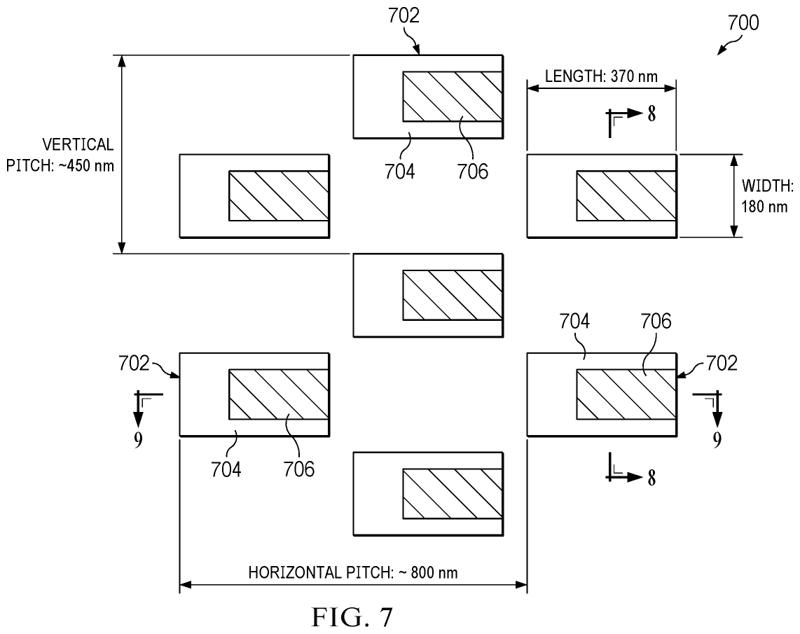

FIG. 7 is a diagram illustrating a cross-section view of a waveguide 700 with three-dimensional varying, repeating gratings in accordance with some embodiments. In embodiments, waveguide 700 is an example implementation of the waveguide 202 of FIG. 2. While gratings like those shown in FIG. 3 are disposed in a substantially two-dimensional configuration with varying depths, e.g., radiating outward from a central location or an edge of a particular geometry, the gratings of FIG. 7 form multi-layered pillars 702, which in some embodiments are formed using similar fabrication techniques to those used to form the gratings of FIG. 3. The multi-layered pillars 702 include at least a first layer 704 and a second layer 706, which in some embodiments are offset from each other to create an asymmetric structure like that shown in FIG. 7. In some embodiments, such as where the multi-layered pillars are utilized in an OC or EPE, the asymmetry of the multi-layered pillars 702 disrupts the balance between the eye-facing and the world-facing sides of the waveguide 700 in order to increase a ratio of display light projected into a user's eye (eye-facing) compared to light projected away from the user's eye (world-facing). In some embodiments, the multi-layered pillars 702 include three or more layers to further bias the light toward the user's eye. Notably, in some embodiments, the multi-layered pillars 702 are located on a world-facing side of the waveguide 700, while in other embodiments, the multi-layered pillars 702 are located on an eye-facing side of the waveguide 700.

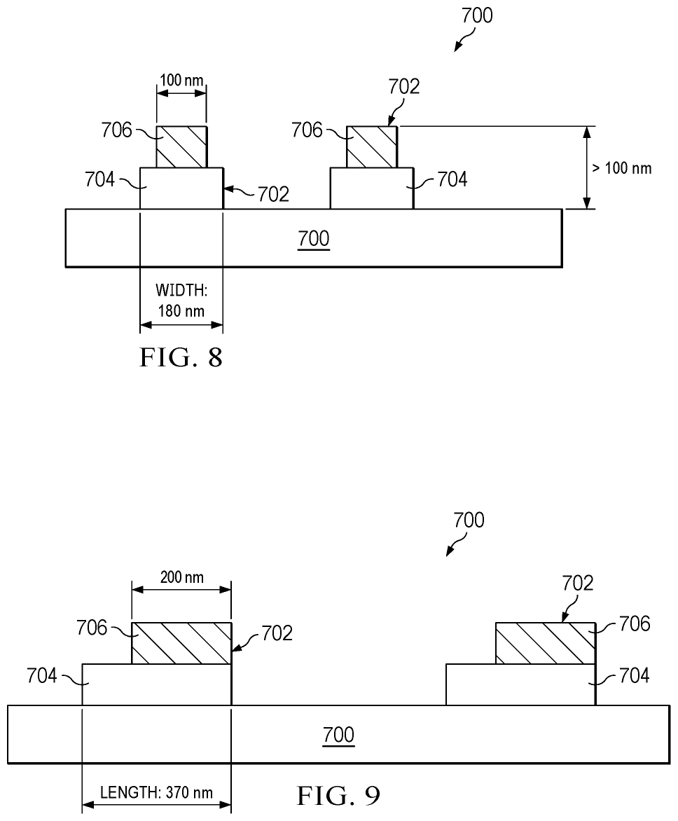

FIG. 8 is a diagram illustrating a cross-sectional view of a portion the waveguide 700 of FIG. 7 along the line 8-8 in accordance with some embodiments, and FIG. 9 is a diagram illustrating a cross-sectional view of a portion of the waveguide 700 of FIG. 7 along the line 9-9 in accordance with some embodiments. It will be understood that the dimensions shown in FIGS. 7-9 are only examples and different dimensions will be used depending on the specific implementation, such as the location of the multi-layered pillars 702 on the waveguide 700 and whether the multi-layered pillars 702 form part of an IC, an OC, or an exit-pupil expander. Generally, the sizes, shapes, horizontal and vertical pitch, and depths of the multi-layered pillars 702, as well as locations of the first layer 704, the second layer 706, and any other layers relative to one another within the multi-layered pillars, are specified, tuned, and/or modulated depending on the specific implementation.

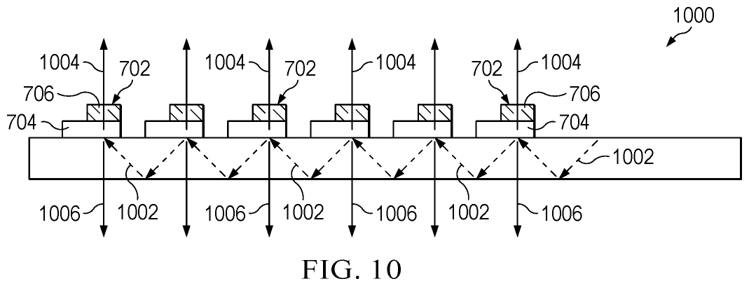

FIG. 10 is a diagram illustrating a cross-section view of a portion of a waveguide 1000 like that of FIG. 7 with varying, repeating grating depths showing an example of light transmission through the waveguide in accordance with some embodiments. As shown, the majority of light 1002 transmitted through the waveguide 1000 is reflected by the multi-layered pillars 702 in the eye-facing direction 1006, while light transmitted through the multi-layered pillars 702 and directed in the world-facing direction 1004 is minimized. Using a waveguide such as the waveguide 1000 of FIG. 10 enables a significant reduction in “eye glow,” i.e., display light meant to be projected in an eye-facing direction 1006 from the waveguide 1000 that instead is projected away from the user's eye in a world-facing direction 1004, compared to implementations that do not use the multi-layered pillars 702.

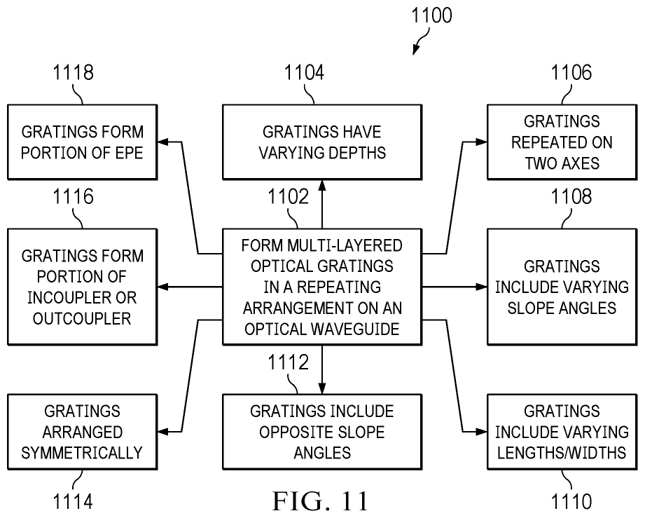

FIG. 11 is a flow diagram of a method 1100 of forming multi-layered optical gratings in a repeated arrangement in accordance with some embodiments. As noted above, the gratings are formed using any appropriate additive or subtractive manufacturing processes, such as deposition, lithography, and/or stamping. At block 1102, the method 1100 includes forming multi-layered optical gratings in a repeating arrangement on an optical waveguide, similar to those shown in FIGS. 3-10. At block 1104, the method 1100 includes forming gratings having varying depths, similar to those shown in FIG. 3. At block 1106, the method 1100 includes forming gratings repeated along two axes, similar to those shown in FIGS. 4 and 7. At block 1108, the method 1100 includes forming gratings having varying slope angles, similar to those shown in FIG. 6. At block 1110, the method 1100 includes forming gratings having varying lengths or widths, similar to those shown in FIGS. 3 and 6-10. At block 1112, the method 1100 includes forming gratings having slope angles facing opposite directions, similar to those shown in FIGS. 5 and 6. At block 1114, the method 1100 includes forming gratings arranged in a symmetric geometry, similar to those shown in FIG. 5. At block 1116, the method 1100 includes forming gratings as at least a portion of an optical IC or OC. At block 1118, the method 1100 includes forming gratings as at least a portion of an optical EPE.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An optical waveguide comprising multi-layered optical gratings disposed in a repeating arrangement.

2. The optical waveguide of claim 1, wherein the gratings have varying depths.

3. The optical waveguide of claim 1, wherein the gratings are repeated along two axes.

4. The optical waveguide of claim 1, wherein the gratings include varying slope angles.

5. The optical waveguide of claim 1, wherein the gratings include varying lengths or widths.

6. The optical waveguide of claim 1, wherein the gratings include slope angles facing opposite directions.

7. The optical waveguide of claim 1, wherein the gratings are arranged in a symmetric geometry.

8. The optical waveguide of claim 1, wherein the gratings form at least a portion of an optical incoupler.

9. The optical waveguide of claim 1, wherein the gratings form at least a portion of an optical outcoupler.

10. The optical waveguide of claim 1, wherein the gratings form at least a portion of an optical exit pupil expander.
